(19) United States
(12) Patent Application Publication
(10) Pub. No.: US 2011/0034128 A1
(43) Pub. Date: Feb. 10, 2011

(54) Mobile Communication Device Linked to In-Vehicle System

(76) Inventor: David M. Kirsch, Torrance, CA (US)

Correspondence Address: Capitol City TechLaw, PLLC, 113 S. Columbus St., Suite 302, Alexandria, VA, 22314, US

(21) Appl. No.: 12/536,205

(22) Filed: Aug. 5, 2009

(51) Int. Cl. H04B 7/00; H04M 1/00; G08G 1/123; G01C 21/26

(52) U.S. Cl. 455/41.3; 455/569.2; 340/988; 701/207

(57) ABSTRACT

An in-vehicle system may detect an occurrence of a triggering event, detect a short-range communication connection between the in-vehicle system and a mobile communication device, send a prompt, including a request for information, to the mobile communication device, and receive a response, including the requested information, from the mobile communication device via the short-range communication module. In some embodiments, a business review, an advertisement, or a redeemable electronic coupon may be sent to the mobile communication device after the requested information is provided. A number of triggering events may be defined. When any of the triggering events are detected by the in-vehicle system, one or more communications may occur between the in-vehicle system and the mobile communication system via the short-range communication connection.

### BACKGROUND

1. Field of the Invention

The present teachings relate to methods, in-vehicle systems, and mobile communication devices in which an in-vehicle system receives information from and sends information to a mobile communication device linked to the in-vehicle system via a short-range communication connection.

2. Discussion of the Related Art

Currently, for hands-free communication within an automobile, a handheld wireless mobile phone in a passenger compartment of an automobile may wirelessly link to an in-vehicle system. Typically, the mobile phone and the in-vehicle system connect to one another using a short-range wireless communication technology, such as Bluetooth® (Bluetooth is a registered trademark of Bluetooth Sig, Inc., a Delaware corporation, with an office in Bellevue, Wash.). Generally, the in-vehicle system is limited to providing only basic phone operations to the wirelessly linked mobile phone, such as phone calls, address book searching, and basic text messaging features.

Today, a user's mobile phone is his/her communication center. For example, a user may use a mobile phone for online banking, phone calls, text messaging, viewing and sending e-mails, instant messaging, Internet searching, as well as other uses. However, existing in-vehicle systems are unable to easily access a mobile phone to communicate messages to a user, such as a driver. One possible solution to this problem is to install a phone module in the automobile and have the in-vehicle system use the phone module to communicate with a user's mobile phone via a standard phone call. However, such a solution may be more expensive and may have future compatibility issues if large changes are made to cellular communication infrastructure.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

An in-vehicle system may detect an occurrence of a triggering event. A triggering event can be a single event, a plurality of events or a plurality of events that occur in a particular order. Examples of triggering events may include: vehicle ignition switch on; vehicle ignition switch off; vehicle located at a particular type of location, opening or closing a door, inserting or removing a key from the ignition, as well as other events. In addition, other example events can include any number of events in combination or in a particular order. Upon detection of a triggering event, the in-vehicle system may communicate with a wireless mobile communication device via a short-range communication link. As an example, when a vehicle ignition switch off triggering event is detected, the in-vehicle system may send information to the wireless mobile communication device, where the information may be stored.

A user may modify at least some of the information stored on the wireless mobile communication device when the user is away from the vehicle. Upon returning to the vehicle, the in-vehicle system may detect a vehicle ignition switch on triggering event. The in-vehicle system may notify the wireless mobile communication device of the detected triggering event, which may cause the wireless mobile communication device to send the stored information to the in-vehicle system via a short-range communication connection.

Some embodiments of the wireless mobile communication device may forward at least some information received from the in-vehicle system to a remote processing device for further processing. Some embodiments of the wireless mobile communication device may also include an application that may be downloaded and installed to a wireless mobile communication device. When executed by the wireless mobile communication device, the application may send information stored on the wireless mobile communication device to an in-vehicle system and/or may receive information from the in-vehicle system for storage on the wireless mobile communication device via a short-range communication link.

### BRIEF DESCRIPTION OF THE DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates an exemplary operating environment of various embodiments.

FIG. 2 is a functional block diagram of an exemplary wireless mobile communication device suitable for use in various embodiments.

FIG. 3 is a functional block diagram of an exemplary in-vehicle system which may be used in a number of embodiments.

FIG. 4 is a functional block diagram of an exemplary server which may be used with some embodiments.

FIGS. 5-10 are flowcharts illustrating exemplary processing which may be performed in various embodiments.

### DETAILED DESCRIPTION

Overview

An in-vehicle system, within a vehicle, may detect an occurrence of a triggering event. A triggering event can be a single event, a plurality of events or a plurality of events that occur in a particular order. Examples of triggering events may include: vehicle ignition switch on; vehicle ignition switch off; vehicle located at a particular type of location, opening or closing a door, inserting or removing a key from the ignition, as well as other single events, or other events in combination or in a particular order. In some embodiments, the in-vehicle system may include a navigation unit and the triggering event may include: (a) detecting the vehicle being located at a particular type of location such as, for example, a point of interest, including a fueling station, a restaurant, a movie theater, or other type of location; (b) detecting the vehicle being located at a fueling station and a refueling door of the vehicle being sensed to be in an open position; and (c) detecting the vehicle being located near a restaurant, to which the navigation unit provided guidance for the vehicle to reach; as well as other triggering events.

Upon detecting the occurrence of a triggering event, the in-vehicle system may determine whether a connection exists between the in-vehicle system and a wireless mobile communication device such as, for example, a mobile phone or other communication device. If the connection exists, the in-vehicle system may send information to the wireless mobile communication device. The in-vehicle system and the wireless mobile communication device may communicate with each other using short-range communication technology such as, a wireless short-range communication technology, for example, Bluetooth® or other short-range communication technology, for example, Universal Serial Bus (USB). The wireless mobile communication device may receive the information and present the information on a display of the wireless mobile communication device.

In some embodiments, the information sent to the wireless mobile communication device may be in the form of a prompt to provide information to the user of the wireless communication device. In some embodiments, the prompt may be presented in a pop-up style window on the display. In other embodiments, the prompt may also request information from a user of the wireless mobile communication device. A user may provide the requested information via the wireless mobile communication device, which may then send the requested information to the in-vehicle system using the short-range communication technology.

In some embodiments, regardless of whether an in-vehicle system does or does not include a navigation system, the in-vehicle system may detect an occurrence of a triggering event and may perform an action involving one or more short-range communications with a wireless mobile communication device.

For example, the in-vehicle system may detect an occurrence of a first type of triggering event and, as a result, may send a prompt to the wireless mobile communication device via a short-range communication connection. The wireless mobile communication device may display the prompt requesting information and a user may provide the requested information via the wireless mobile communication device. The wireless mobile communication device may then send the requested information to the in-vehicle system.

When the in-vehicle system detects an occurrence of a second type of triggering event, the in-vehicle system may send, via the short-range communication connection, second information to the wireless mobile communication device, which may then receive and store the second information and/or may send the second information to a remote processor, such as, for example, a server. In some embodiments, the second type of triggering event may include turning a vehicle ignition switch off, or other triggering event, and the second information may include vehicle status information, or other information.

When the in-vehicle system detects an occurrence of a third type of triggering event, the in-vehicle system may send to the wireless mobile communication device, via the short-range communication connection, an indication of the occurrence of the third type of triggering event. In response to receiving the indication, the wireless mobile communication device may send stored second information to the in-vehicle system via the short-range communication connection. In some embodiments, the third type of triggering event may include turning a vehicle ignition switch on, or other triggering event.

Examples of how embodiments may be used may include, but not be limited to: (a) detecting a vehicle being located at a fueling station, detecting an existing connection between an in-vehicle system and a wireless mobile communication device, sending a prompt to the wireless mobile communication device requesting information regarding a price of fuel per unit and a number of units purchased, and receiving a response, from the wireless mobile communication device, including the requested information from the user; (b) detecting the vehicle being located near a restaurant, to which the in-vehicle system provided the vehicle with navigation guidance, detecting an existing connection between an in-vehicle system and a wireless mobile communication device, sending a prompt to the wireless mobile communication device requesting the user to provide information regarding a dining experience at the restaurant, and receiving a response, including the information, from the wireless mobile communication device; and (c) detecting the vehicle being located near a movie theater, to which the in-vehicle system provided navigation guidance, detecting an existing connection between an in-vehicle system and a wireless mobile communication device, sending a prompt to the wireless mobile communication device requesting the user to provide information regarding a movie viewing experience at the movie theater, and receiving a response, including the information, from the wireless mobile communication device.

In some embodiments, an application may be downloaded and installed to a wireless mobile communication device. When executed by the wireless mobile communication device, the application may send information stored on the wireless mobile communication device to an in-vehicle system and/or may receive information from the in-vehicle system for storage on the wireless mobile communication device via a short-range communication link. As new types of communications may be developed for communicating between an in-vehicle system and a wireless mobile communication device, an updated application may be downloaded and installed to the wireless mobile communication device. In addition, when a user replaces a wireless mobile communication device with an updated wireless mobile communication device, an updated application may be downloaded and installed to the updated wireless mobile communication device, such that types of messages communicated between the in-vehicle system and a previous wireless mobile communication device, may continue to be communicated between the in-vehicle system and the updated wireless mobile communication device, as well as supporting new types of messages.

Exemplary Operating Environment

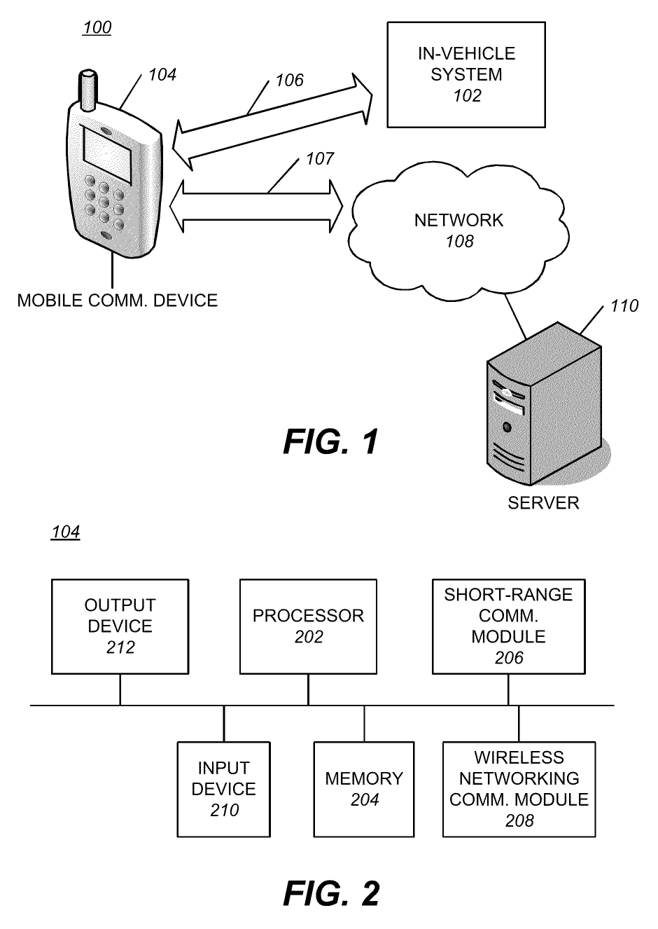

FIG. 1 illustrates an exemplary operating environment 100 for various embodiments. Operating environment 100 may include an in-vehicle system 102, a wireless mobile communication device 104, a short-range communication link 106 between wireless mobile communication device 104 and in-vehicle system 102, a wireless networking communication link 107 between wireless mobile communication device 104 and a network 108, and a processing device, such as a server 110 connected to network 108.

In-vehicle system 102 and wireless mobile communication device 104 may communicate with each other via a short-range communication link 106, which uses short-range communication technology, such as, for example, Bluetooth® technology or other short-range communication technology, for example, Universal Serial Bus (USB). In-vehicle system 102 and wireless mobile communication device 104 may attempt to connect, or pair, with each other via short-range communication link 106. In-vehicle system 102 may send information to wireless mobile communication device 104 in response to detecting an occurrence of a triggering event. The information may be sent in the form of a prompt, or other message, that may or may not request information from the user of the wireless mobile communication device 104. Wireless mobile communication device 104 may send information to in-vehicle system 102 via short-range communication link 106 in response to a triggering event, a message and/or a prompt received from in-vehicle system 102. Wireless mobile communication device 104 may store information received from in-vehicle system 102, and/or may provide the information to a remote processing device, such as, for example, server 110, via network 108.

In some embodiments, in-vehicle system 102 may provide information to the wireless mobile communication device 104. Wireless mobile communication device 104 may use that information to obtain additional information from network 108 and/or server 110. The additional information may also be obtained in response to providing information with respect to a prompt on wireless mobile communication device 104 from in-vehicle system 102. The additional information may be in the form of a business review, an advertisement and/or an electronic coupon. The electronic coupon may be redeemed, at a later time, for a discount on goods or services and may provide an incentive for a user to provide the requested information.

Network 108 may include a wireless communication network, such as, for example, a cellular telephony network, as well as one or more other networks, such as, the Internet, a public-switched telephone network (PSTN), a packet-switching network, a frame-relay network, a fiber-optic network, and/or other types of networks.

Exemplary Devices

FIG. 2 is a functional block diagram of an exemplary embodiment of wireless mobile communication device 104. Wireless mobile communication device 104 may include a processor 202, a memory 204, a short-range communication module 206, a wireless networking communication module 208, an input device 210, and an output device 212.

Processor 202 may include one or more conventional processors that interpret and execute instructions stored in a tangible medium, such as memory 204, a media card, flash RAM, or other tangible medium. Memory 204 may include random access memory (RAM) or another type of dynamic storage device, and read-only memory (ROM) or another type of static storage device, for storing this information and instructions for execution by processor 202. RAM, or another type of dynamic storage device, may store instructions as well as temporary variables or other intermediate information used during execution of instructions by processor 202. ROM, or another type of static storage device, may store static information and instructions for processor 202.

Short-range communication module 206 may include a first transceiver for transmitting and receiving information via a wireless short-range communication technology such as, for example, Bluetooth® or other short-range communication technology, for example, Universal Serial Bus (USB). Wireless networking communication module 208 may include a second transceiver for transmitting and receiving information via a wireless communication network, including but not limited to a cellular telephony network.

Input device 210 may include hard keys and/or soft keys, a microphone, a touchscreen, and/or other input device. Output device 212 may include a speaker and/or a display.

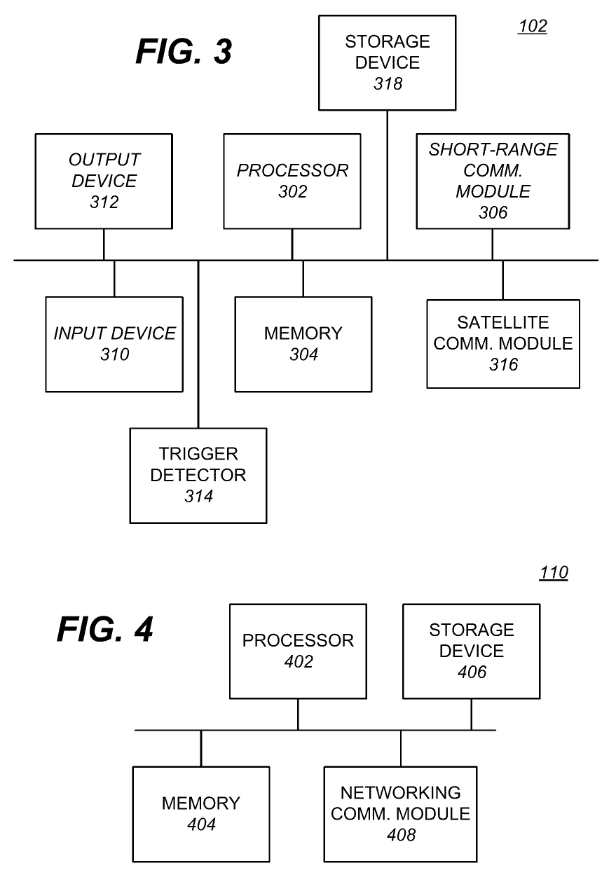

FIG. 3 is a functional block diagram of an exemplary embodiment of in-vehicle system 102. In-vehicle system 102 may include a processor 302, a memory 304, a short-range communication module 306, an input device 310, an output device 312, a trigger detector 314, a satellite communication module 316, and a storage device 318.

Processor 302 may include one or more conventional processors that interpret and execute instructions stored in a tangible medium, such as memory 304, a media card, flash RAM, or other tangible medium. Memory 304 may include random access memory (RAM), or another type of dynamic storage device, and/or read-only memory (ROM), or another type of static storage device, for storing information and instructions for execution by processor 302. RAM, or another type of dynamic storage device, may store instructions as well as temporary variables or other intermediate information used during execution of instructions by processor 302. ROM, or another type of static storage device, may store static information and instructions for processor 302.

Short-range communication module 306 may include a transceiver for transmitting and receiving information via a wireless short-range communication technology such as, for example, Bluetooth® or other short-range communication technology, for example, Universal Serial Bus (USB).

Input device 310 may include hard keys and/or soft keys, a microphone, a touchscreen, and/or other input device. Output device 312 may include a speaker and/or a display.

Trigger detector 314 may detect an occurrence of a triggering event. Trigger detector 314 may be a mechanism that can detect a change of state of a vehicle system or vehicle sensor. Trigger detector 314 can be implemented in hardware, software or a combination thereof. A triggering event can be a single event, a plurality of events or a plurality of events that occur in a particular order. Examples of triggering events may include: vehicle ignition switch on; vehicle ignition switch off; vehicle located at a particular type of location, opening or closing a door, inserting or removing a key from the ignition, as well as other single events, or other events in combination or in a particular order. In various embodiments, actual triggering events may vary from the above-mentioned examples.

In some embodiments, components of in-vehicle system 102 may include a navigation unit for guiding a vehicle, including in-vehicle system 102, to a destination. That is, at least some components of in-vehicle system 102 may function together as a navigation unit. When in-vehicle system 102 includes a navigation unit, in-vehicle system 102 may include a satellite communication module 316 for communicating with global positioning satellites.

FIG. 4 is a functional block diagram of an exemplary embodiment of server 110. Server 110 may include a processor 402, a memory 404, a storage device 406, and a networking communication module 408.

Processor 402 may include one or more conventional processors that interpret and execute instructions stored in a tangible medium, such as memory 404, a media card, flash RAM, or other tangible medium. Memory 404 may include random access memory (RAM) or another type of dynamic storage device, and read-only memory (ROM) or another type of static storage device. RAM, or another type of dynamic storage device, may store instructions as well as temporary variables or other intermediate information used during execution of instructions by processor 402. ROM, or another type of static storage device, may store static information and instructions for processor 402.

Networking communication module 408 may include a transceiver for transmitting and receiving information via a wired or wireless communication network, such as network 108 or other network.

Exemplary Processes

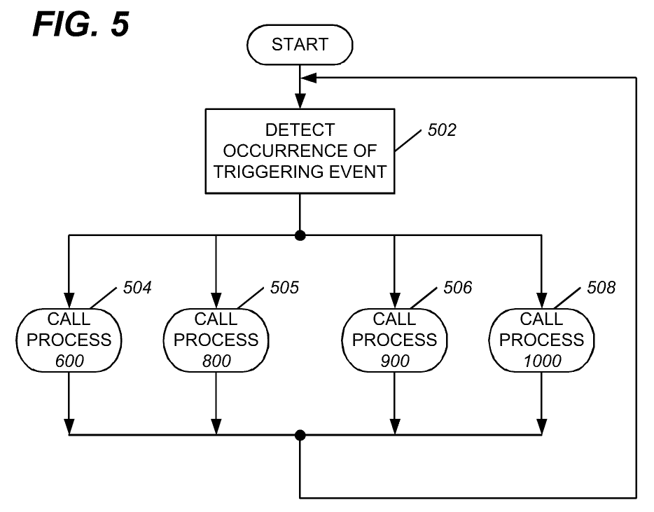

FIG. 5 is a flowchart illustrating exemplary processing in an embodiment. The process may begin with in-vehicle system 102 determining whether a triggering event has occurred (act 502). If no triggering event has occurred, then in-vehicle system 102 may continue to wait for an occurrence of a triggering event.

If a triggering event has occurred, then in-vehicle system 102 may call process 600 (act 504), call process 800 (act 505), call process 900 (act 506), or call process 1000 (act 508), depending upon a type of triggering event detected.

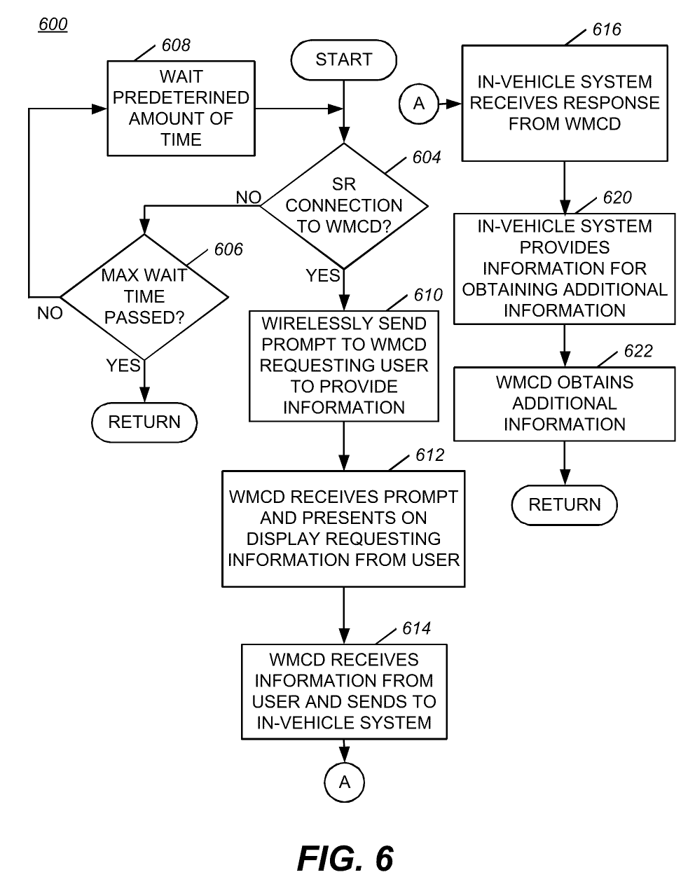

FIG. 6 illustrates exemplary processing with respect to process 600. The process may begin with in-vehicle system 102 determining whether a connection exists with wireless mobile communication device 104 (act 604).

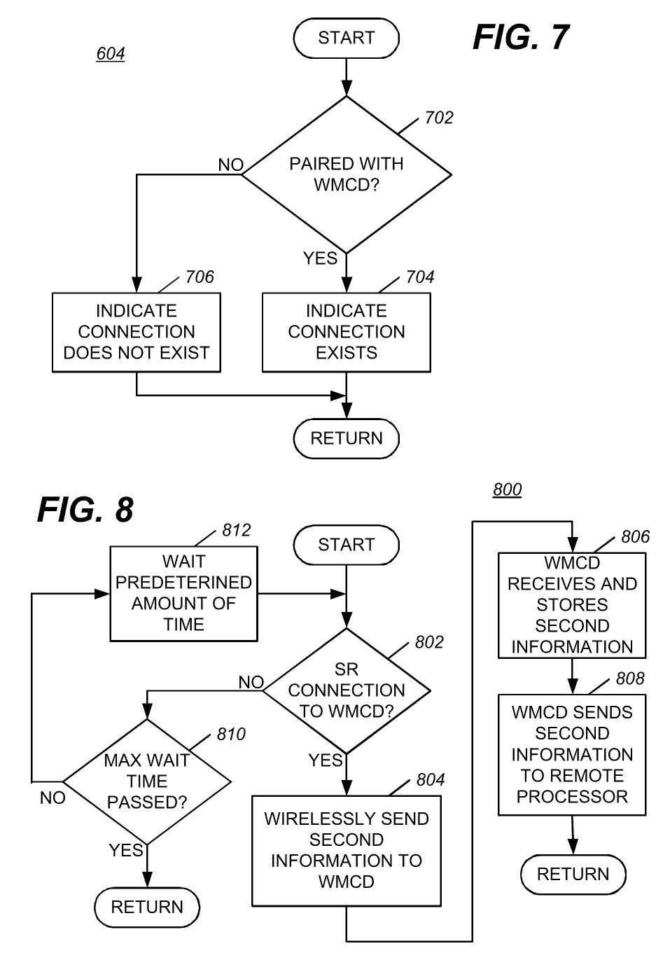

FIG. 7 is a flowchart illustrating act 604. The process may begin with in-vehicle system 102 determining whether a pairing relationship exists between the in-vehicle system 102 and wireless mobile communication device 104 (act 702). The pairing relationship may use Bluetooth® technology in some embodiments. If the pairing relationship is determined to exist, then an indication may be returned indicating that a connection exists (act 704). Otherwise, an indication may be returned indicating that a connection does not exist (act 706).

Returning to FIG. 6, if no connection is determined to exist with wireless mobile communication device 104, then in-vehicle system 104 may determine whether a maximum waiting time has passed (act 606). The maximum waiting time may be 60 seconds or another suitable time period. If the maximum waiting time has passed, then in-vehicle system 102 may wait a pre-determined amount of time, such as, for example, 10 seconds, or another suitable time period before performing act 604 again.

If, during act 606, in-vehicle system 102 determines that the maximum waiting time has passed, then in-vehicle system 102 may simply cause control to be returned to a calling program and processing with respect to the triggering event may be discarded.

If, during act 604, in-vehicle system 102 determines that a connection exists with wireless mobile communications device 104, then in-vehicle system 102 may wirelessly send a prompt, via short-range communication module 306, to wireless communication device 104 requesting information from a user (act 610). Wireless mobile communication device 104 may receive the prompt and may present the prompt on a display of wireless communication device 104 (act 612). In some embodiments, the prompt may be presented in a pop-up style on the display. The displayed prompt may include one or more areas for the user to provide requested information. Wireless mobile communication device 104 may receive the requested information from the user and may send the requested information to in-vehicle system 102 via short-range communication link 106 (act 614).

In-vehicle system 102 may receive the response from wireless mobile communication device 104 via short-range communication link 106 (act 616). Next, in-vehicle system 102 may provide information for obtaining additional information to wireless mobile communication device 104 (act 620). The additional information may be in the form of a business review, an advertisement and/or an electronic coupon. Wireless mobile communication device 104 may then obtain the additional information (act 622). In some embodiments, wireless mobile communication device 104 may obtain the additional information from server 110. In other embodiments, wireless mobile communication device 104 may obtain the additional information from other sources.

Wireless mobile communication device 104 may store the additional information, such that the additional information may not be altered by the user. Eventually, act 502 may again be performed to detect, or wait for, an occurrence of a next triggering event.

Returning to FIG. 5, if the detected triggering event is of a second type, then in-vehicle system 102 may call process 800. In some embodiments, the second type of triggering event includes a vehicle ignition switch on event.

FIG. 8 is a flowchart illustrating exemplary processing with respect to a detected occurrence of the second type of triggering event. The process may begin with in-vehicle system 102 determining whether a connection exists between in vehicle system 102 and wireless mobile communication device 104 (act 802). In various embodiments, processing with respect to act 802 may be identical to the exemplary processing illustrated in FIG. 7.

If in-vehicle system 102 determines that a connection with a wireless mobile communication device 104 exists, via short-range communication link 106, then in-vehicle system 102 may send second information to wireless mobile communication device 104 via short-range communication link 106 (act 804). In some embodiments, second information may include vehicle status information. Vehicle status information may include a current odometer reading, a trip odometer reading, average miles per gallon, average speed, estimated distance until refueling, estimated oil life, last maintenance date, last maintenance odometer reading, tire pressure, next maintenance odometer reading, dealer information, interior lighting settings, and/or door lock settings, as well as other vehicle status information. The above-listed examples of vehicle status information are only exemplary. In other embodiments, actual vehicle status information may vary from the above.

Wireless mobile communication device 104 may receive the second information and may store the second information (act 806) and/or may send the second information to a remote processor, such as, for example, server 110 or another remote processor (act 808).

If, during act 802, in-vehicle system 102 determines that a short-range connection between in-vehicle system 102 and wireless mobile communication device 104 does not exist, then in-vehicle system 102 may determine whether a maximum amount of time has passed, such as, for example, 60 seconds, or another suitable time period (act 810). If the maximum amount of time has passed, then in-vehicle system 102 may cause control to return to a calling program. Otherwise, in-vehicle system 102 may wait a predetermined amount of time, such as, for example, 10 seconds, or another suitable time period (act 812) before again performing act 802.

Returning to FIG. 5, when a third type of triggering event is detected, in-vehicle system 102 may call process 900 (act 506).

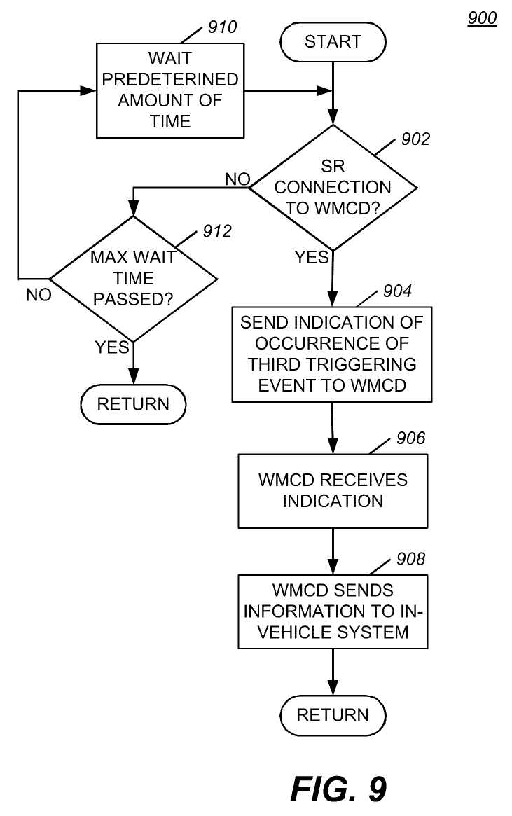

FIG. 9 illustrates is a flowchart illustrating exemplary processing with respect to a detected occurrence of a third type of triggering event. The process may begin with in-vehicle system 102 determining whether a short-range communication connection exists between in vehicle system 102 and wireless mobile communication device 104 (act 902). In various embodiments, processing with respect to act 902 may be identical to the exemplary processing illustrated in FIG. 7.

If, during act 902, in-vehicle system 102 determines that a short-range communication connection between in-vehicle system 102 and wireless mobile communication device 104 exists, then in-vehicle system 102 may send an indication of an occurrence of a third triggering event to a wireless mobile communication device 104 via the short-range communication connection (act 904). Wireless mobile communication device 104 may receive the indication via the short-range communication connection (act 906) and may send information to in-vehicle system 102 (act 908).

In one embodiment, the third type of triggering event may be a vehicle ignition switch on event and in-vehicle system 102 may inform wireless mobile communication device 104 of an occurrence of the vehicle ignition switch on event. Upon being notified of the occurrence of the vehicle ignition switch on event, wireless mobile communication device 104 may send information to in vehicle system 102, such as, for example, vehicle status information, or another type of information.

Returning to a FIG. 5, when a fourth type of triggering event is detected, in-vehicle system 102 may call process 1000 (act 508).

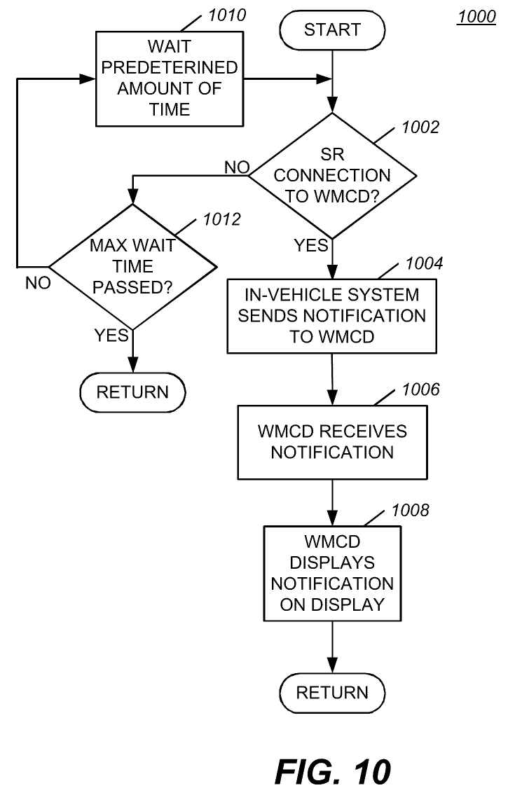

FIG. 10 is a flowchart illustrating exemplary processing with respect to a detected occurrence of a fourth type of triggering event. The process may begin with in-vehicle system 102 determining whether a short-range communication connection exists between in-vehicle system 102 and wireless mobile communication device 104 (act 1002). In various embodiments, processing with respect to act 1002 may be identical to the exemplary processing illustrated in FIG. 7.

If, during act 1002, in-vehicle system 102 determines that a short-range communication connection between in-vehicle system 102 and wireless mobile communication device 104 exists, then in-vehicle system 102 may send a notification to wireless mobile communication device 104 (act 1004). The notification may include information such as, “vehicle lights left on”, or another notification. Wireless mobile communication device 104 may then display the notification on a display screen.

The above-described processes are only exemplary. For example, the above exemplary processes discuss four types of triggering events. However, in other embodiments, fewer than four types of triggering events, or more than four types of triggering events may be defined.

Further, in an embodiment in which wireless mobile communication device 104 receives and stores an electronic coupon, the electronic coupon may be redeemed in a number of different ways. For example, the electronic coupon may be displayed on the display of wireless mobile communication device 102 and presented to a merchant. The merchant may honor the electronic coupon and may enter a specific code on wireless mobile communication device 104 to either delete the electronic coupon or indicate redemption of the electronic coupon. In another embodiment, the electronic coupon may be sent to a merchant's device, either via infrared light transmissions, via a physical connection with the merchant device, or via another transmission means. Upon completion of sending of electronic coupon to the merchant's device, wireless mobile communication device 104 may delete the electronic coupon.

Conclusion

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they are not to be construed as limiting the claims in any way. Other configurations of the described embodiments are part of the scope of this disclosure. In addition, acts illustrated by the flowcharts of FIGS. 5-10 may be performed in a different order in other embodiments, and may include additional or fewer acts. For example, in some embodiments, instead of detecting a triggering event and then determining that a short-range communication connection with a wireless mobile communication device exists before communicating with the wireless mobile communication device, an in-vehicle system, instead, may detect an occurrence of a triggering event only when the short-range connection is determined to exist. Further, in other embodiments, other devices or components may perform portions of the acts described above. Accordingly, the appended claims and their legal equivalents define the invention, rather than any specific examples given.

I claim as my invention:

1. An in-vehicle system for use in a vehicle, the in-vehicle system comprising:
a trigger detector for detecting an occurrence of any one of a plurality of triggering events; and
a short-range communication module for sending a prompt to a mobile communication device for first information from a user, the prompt to be sent when the trigger detector detects an occurrence of a first type of triggering event, and the short-range communication module being further for receiving the first information provided by the user via the mobile communication device in response to the prompt.

2. The in-vehicle system of claim 1, wherein:
the short-range communication module communicates with the mobile communication device via Bluetooth® technology.

3. The in-vehicle system of claim 1, wherein the short-range communication module is further for sending second information to the mobile communication device when the trigger detector detects an occurrence of a second type of triggering event.

4. The in-vehicle system of claim 3, wherein the second information includes vehicle status information.

5. The in-vehicle system of claim 1, wherein the short-range communication module is further for requesting and receiving vehicle status information from the mobile communication device when the trigger detector detects an occurrence of a third type of triggering event.

6. The in-vehicle system of claim 1, wherein the mobile communication device includes a wireless mobile phone.

7. The in-vehicle system of claim 1, further comprising:
a navigation unit, wherein:
a fourth type of triggering event includes the navigation unit determining that a vehicle, including the in-vehicle unit, is located at a location of a particular type, and
the prompt includes a request for the user to provide the first information regarding the location of the particular type.

8. The in-vehicle system of claim 7, wherein the location of the particular type includes a fueling station, a movie theater, or a restaurant.

9. The in-vehicle system of claim 7, wherein:
when the short-range communication module receives a response to the prompt from the mobile communication device, the short range communication module transmits, to the mobile communication device, information for obtaining an electronic coupon, an advertisement, or a business review.

10. A method implemented on a wireless mobile communication device, the method comprising:
receiving, by the wireless mobile communication device from an in-vehicle system via a short-range communication connection, a prompt for first information;
displaying, on a display of the wireless mobile communication device and in response to the receiving of the prompt for the first information, a request for the first information;
receiving, by the wireless mobile communication device, the requested first information inputted by a user; and
sending, via the short-range communication connection, the requested first information from the wireless mobile communication device to the in-vehicle system.

11. The method of claim 10, further comprising:
receiving, by the wireless mobile communication device via the short-range communication connection, second information from the in-vehicle system; and
storing the second information at the wireless communication device.

12. The method of claim 10, further comprising:
receiving, by the wireless mobile communication device via the short-range communication connection, second information from the in-vehicle system; and
sending the second information from the wireless mobile communication device to a remote processing device.

13. The method of claim 10, further comprising:
executing a previously downloaded and installed application on the wireless mobile communication device, the executing application causing the wireless mobile communication device to perform:
the displaying of the request for the first information when the prompt for the first information is received, and
the sending of the requested first information from the wireless mobile communication device to the in-vehicle system when the requested first information is inputted by the user.

14. The method of claim 13, wherein the executing application further causes the wireless mobile communication to perform:
receiving of second information from the in-vehicle system, and
storing the second information in the wireless mobile communication device.

15. The method of claim 13, wherein the executing application further causes the wireless mobile communication to perform:
receiving of second information from the in-vehicle system, and
sending the second information to a remote processing device.

16. The method of claim 13, wherein the executing application further causes the wireless mobile communication to perform:
receiving and storing third information for obtaining one item of a group of items comprising a business review, an advertisement, or a redeemable electronic coupon, and
obtaining the one item.

17. The method of claim 10, further comprising:
receiving an indication of an occurrence of a triggering event; and
sending previously-stored information from the wireless mobile communication device to the in-vehicle system via the short-range communication connection after receiving the indication of the occurrence of the triggering event.

18. The method of claim 10, further comprising:
receiving, by the wireless mobile communication device via the short-range communication connection, vehicle status information; and
displaying, on a display of the wireless communication device, a notification related to the received vehicle status information.

19. A method implemented on an in-vehicle system, the method comprising:
detecting, by the in-vehicle system, an occurrence of a first type of triggering event;
sending, from the in-vehicle system to a wireless mobile communication device via a short-range communication connection, a prompt for first information in response to the detecting of the occurrence of the first type of triggering event; and
receiving, by the in-vehicle system from the wireless mobile communication device via the short-range communication connection, the first information provided by a user of the wireless mobile communication device.

20. The method of claim 19, further comprising:
detecting, by the in-vehicle system, an occurrence of a second type of triggering event;
informing, by the in-vehicle system to the wireless mobile communication device, of the occurrence of the second type of triggering event via the short-range communication connection; and
receiving, by the in-vehicle system, previously-stored vehicle information from the wireless mobile communication device via the short-range communication connection in response to the informing.

21. The method of claim 19, wherein the detecting of an occurrence of a first one of a plurality of events further comprises:
determining, by a navigation unit included in the in-vehicle system, a vehicle including the in-vehicle system being at a particular type of location.

22. The method of claim 21, wherein the particular type of location includes a fueling station, a movie theater, or a restaurant.

23. A method implemented on an in-vehicle system, the method comprising:
detecting, by the in-vehicle system, an occurrence of a first type of triggering event;
sending, from the in-vehicle system to a wireless mobile communication device via a short-range communication connection, a request for previously-stored first information in response to the detecting of the occurrence of the first type of triggering event; and
receiving, by the in-vehicle system from the wireless mobile communication device via the short-range communication connection, the requested previously-stored first information after the sending of the request for the previously-stored first information.
